(19) United States
(12) Patent Application Publication
(10) Pub. No.: US 2025/0001944 A1
(43) Pub. Date: Jan. 2, 2025

(54) STORAGE CABINETS AND STORAGE CABINET SYSTEMS FOR AFTERMARKET INSTALLATION IN A TAILGATE OF A VEHICLE AND RELATED METHODS

(71) Applicant: South East Manufacturing Inc., Wilson, NC (US)

(72) Inventors: Zachary Hall, Lucama, NC (US); Timothy Martin, New Bern, NC (US); Nicholas Martin, New Bern, NC (US)

(21) Appl. No.: 18/759,235

(22) Filed: Jun. 28, 2024

Related U.S. Application Data
(60) Provisional application No. 63/523,849, filed on Jun. 28, 2023.

(51) Int. Cl. B60R 7/02; B60R 7/08; B60R 11/00

(52) U.S. Cl. CPC B60R 7/02; B60R 7/087; B60R 2011/0021; B60R 2011/0036; B60R 2011/0075; B60R 2011/0096

(57) ABSTRACT

Apparatuses and systems of storage for incorporation into a tailgate of a vehicle and related methods are provided herein. A storage cabinet for securing in a tailgate of a vehicle can include a cabinet body having a compartment structure having one or more compartment cavities that open on a face side of the compartment structure within the compartment structure and an exterior cabinet wall structure securable to the compartment structure and configured to form at least a front face of the cabinet body. The compartment structure of the cabinet body can be configured to reside within an opening of the tailgate of the vehicle. The storage cabinet can include a cabinet door configured to attach the cabinet wall structure to close the one or more compartment cavities in the compartment structure.

### RELATED APPLICATION

The present application and presently disclosed subject matter claims the benefit of U.S. Provisional Patent Application Ser. No. 63/523,849, filed Jun. 28, 2023, the disclosure of which is incorporated herein by reference in its entirety.

### TECHNICAL FIELD

The present subject matter relates to apparatuses and systems of storage for incorporation into a tailgate of a vehicle and related methods. In particular, the present subject matter relates to cabinets, such as medicine cabinets, which can be installed on an inward facing portion of a tailgate of a vehicle to provide extra storage that can be designated for specific uses, such as medicine and medical supplies, so that the user of the vehicle knows where to locate them when needed.

### BACKGROUND

Sports Utility Vehicles (“SUVs”) have gained tremendous popularity over the past several years and have quickly become one of the most common body types you will see on the road. A big reason why SUVs are so popular is due to versatility and cargo space. Smaller SUVs are great for commuters or small families that need a bit more room than a sedan or hatchback can provide. Many SUVs offer even more space inside the cabin, with a large range of sizes available, including compact and full-size mode. SUVs also tend to offer a wide range of drivetrain options. Front-wheel drive is common as an affordable and fuel-efficient option for drivers. All-wheel drive is a popular choice among SUV drivers in that it helps them handle the vehicle easier in slippery road conditions. Some SUVs offer rear-wheel drive. For drivers how enjoy outdoor activities, many SUVs offer four-wheel drive for enhanced performance.

Some SUVs, such as Jeeps® and the new Ford Broncos®, have been designed to be highly customizable with modular designs that permit companies to provide aftermarket parts and additional components that add features no offered on the respective vehicles by the manufacturer. For example, off-road modular SUV designs offer a user-friendly platform that can be stripped to its base structure so that alternate doors, fenders, and grille can be added in one afternoon. The following day, a whole new SUV can be reconfigured for another new adventure with a different body and roof setup. Such SUVs were designed and engineered from a clean slate to make off-road customization easy, quick, and attainable for all enthusiasts with a wide variety of interests and skill levels.

Due to the customizability available in many vehicles, a wide range of uses from regular transportation needs to off road adventuring in different environments, including, desert, beach, mountain, mud, and rocky environments, other possible accessible storage needs can arise. These accessible storage needs can include fire extinguisher holders, flashlight holder, overhead or dome lighting, or a lockable safe. Other accessible storage needs can include attachment of an overhead MOLLE (modular light-weight load-carrying equipment) panel, a mount for radio such as a CB, and a mount for auxiliary or other accessory switches for accessories added during the customization of the SUV. Larger storage containers that can be locked to limit access can be desirable to storage items and goods to which access should be limited or items that should be protected for future use. For example, such items can include medical supplies or medicine, weapons, such as pistols, money or other valuables which need to be kept in a safe and dry space. Unfortunately, many such SUVs provide limited safe, dry, and secure containment space.

As such, a need exists for storage cabinets that can be used in such sport utility vehicles.

### SUMMARY

The present subject matter relates to storage cabinets and storage cabinet systems for incorporation into a tailgate of a vehicle and related methods. In particular, the present subject matter relates to cabinets, which can be installed on an inward facing portion of a tailgate of a vehicle to provide extra storage that can be designated for specific uses, so that the user of the vehicle can know where specific items are located when they are needed. Methods related to the use and assembly of the storage cabinets disclosed herein are also provided.

Thus, it is an object of the presently disclosed subject matter to provide storage cabinets and systems of storage for incorporation into a tailgate of a vehicle as well as methods related thereto. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIGS. 1A, 1B, 1C and 1D illustrate perspective views of a rear of a vehicle having a swingout tailgate that is opened with an embodiment of a storage cabinet according to present subject matter installed in the tailgate;

FIGS. 2A and 2B illustrate side perspective views of an embodiment of a storage cabinet according to present subject matter with the storage cabinet in FIG. 2A being closed and the storage cabinet in 2B being open;

FIG. 3 illustrates an exploded perspective view of the embodiment of the storage cabinet according to FIGS. 2A and 2B, including embodiments of a bracket, and a gasket according to the present subject matter;

FIG. 4A illustrate a perspective view of the embodiment of the storage cabinet according to FIGS. 2A and 2B;

FIG. 4B illustrate a top plan view of the embodiment of the storage cabinet according to FIGS. 2A and 2B;

FIG. 5A illustrate a right side plan view of the embodiment of the storage cabinet according to FIGS. 2A and 2B;

FIG. 5B illustrate a front plan view of the embodiment of the storage cabinet according to FIGS. 2A and 2B;

FIG. 5C illustrate a left side plan view of the embodiment of the storage cabinet according to FIGS. 2A and 2B;

FIG. 6A illustrates a right side plan view of embodiments of a compartment structure, a bracket, and a gasket of an embodiment of a storage cabinet according to present subject matter;

FIG. 6B illustrates a front plan view of embodiments of a compartment structure, a bracket, locking plate, and a gasket of an embodiment of a storage cabinet according to present subject matter;

FIG. 7A-7C illustrates different views of an embodiment of an exterior cabinet wall structure of an embodiment of a storage cabinet according to present subject matter; and

FIG. 8 illustrates a perspective view of an embodiment of a door of an embodiment of a storage cabinet according to present subject matter.

Repeat use of reference characters in the present specification and drawings is intended to represent the seam or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, top, bottom, etc. may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer, or section. Thus, a first feature, element, component, region, layer, or section discussed below could be termed a second feature, element, component, region, layer, or section without departing from the teachings of the disclosure herein.

Similarly, when a feature or element is being described in the present disclosure as “on” or “over” another feature or element, it is to be understood that the features or elements can either be directly contacting each other or have another feature or element between them, unless expressly stated to the contrary. Thus, these terms are simply describing the relative position of the features or elements to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements, or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not necessarily intended to limit the scope of the subject matter disclosed herein unless it specifically stated otherwise herein.

As used herein, the term a “plurality” means two or more.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5.

Some vehicles, such as a Ford Broncos®, have tailgates that have side hinges that permit the tailgates swing outward. These swingout tailgates are connected to the frame of the vehicle by a hydraulic hinge that secures to the tailgate at a single location on the tailgate. On these vehicles, such as a Ford Broncos®, the end of the tailgate opposite the hinges can include a latching mechanism that holds the tailgate closed against the frame when shut and releases the tailgate from the frame with the tailgate is opened. The latch can be located in a latching hull proximate to the latching end of the tailgate. The latching hull can extend outward from an interior face of the tailgate and can provide an access aperture that permits easy access for maintenance and repair of the latching mechanism.

The present subject matter relates to apparatuses and systems of storage for incorporation into a tailgate of a vehicle, such as a Ford Bronco®. In particular, the present subject matter relates to cabinets, such as medicine cabinets, which can be installed in the access aperture in an interior facing portion of a tailgate of the vehicle to provide extra storage that can be designated for specific uses so that the user of the vehicle knows where to locate them when needed. In particular, storage cabinets, storage cabinet systems for incorporation into a tailgate of a vehicle and related methods are provided herein. For example, a storage cabinet can be provided that is configured to reside in a tailgate of a vehicle. The storage cabinet can comprise a cabinet body comprising a compartment structure having one or more compartment cavities that open on a face side of the compartment structure within the compartment structure. The compartment structure of the cabinet body can be configured to reside within an opening of the tailgate of the vehicle. The storage cabinet can also comprise an exterior cabinet wall structure that can be secured to the compartment structure. The exterior cabinet wall structure can be configured to form at least a front face of the cabinet body. Additionally, the storage cabinet can comprise a cabinet door configured to attach the exterior cabinet wall structure to close the one or more compartment cavities in the compartment structure.

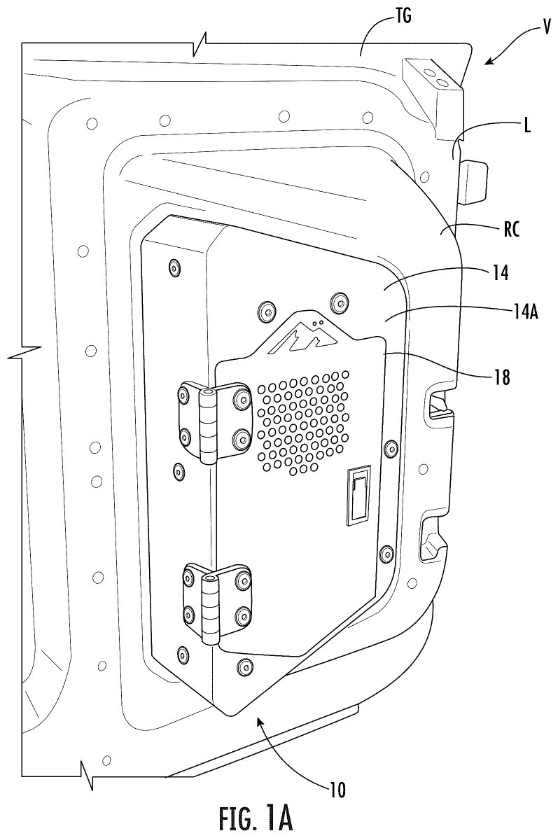

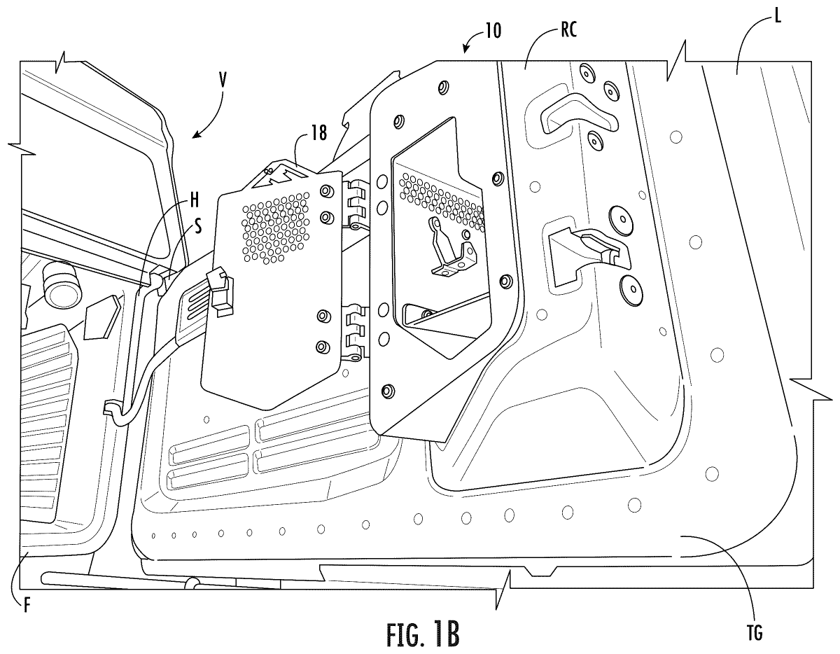

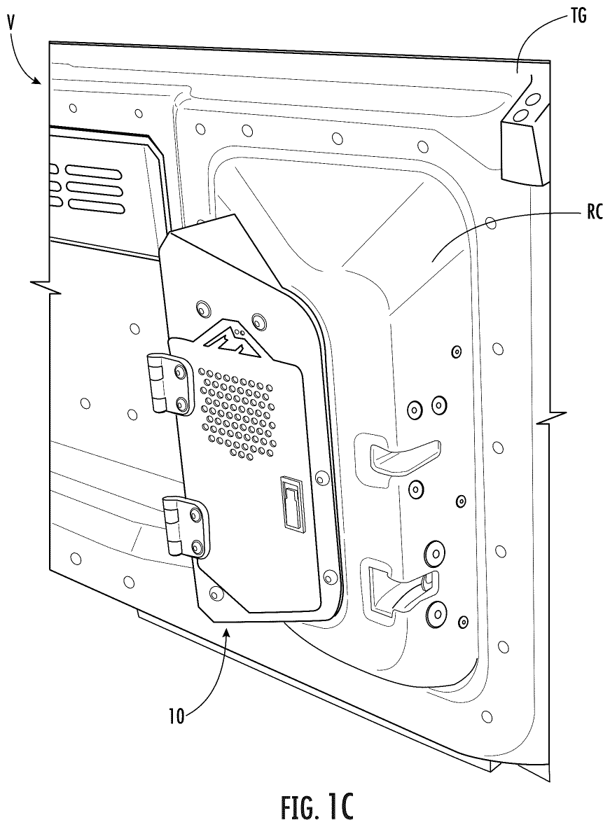

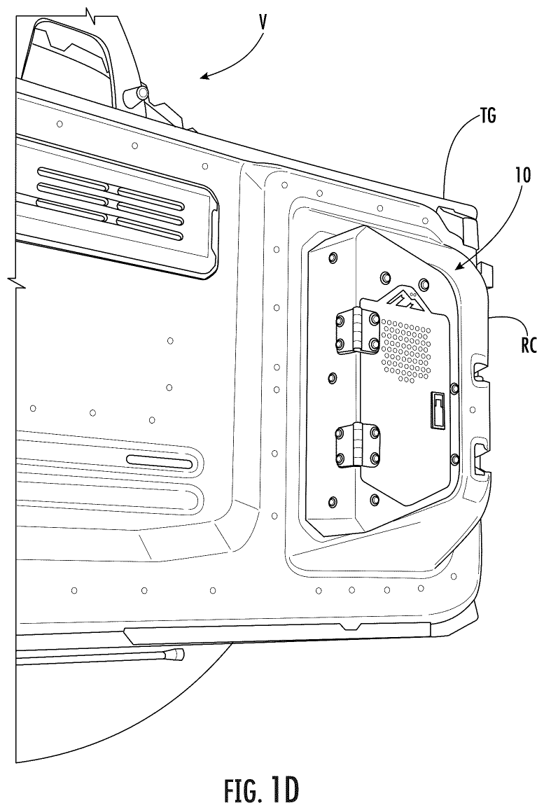

Referring to FIGS. 1A-1C, a tailgate TG of a vehicle V is provided. For example, as stated above, the vehicle V can be a sports utility vehicle such as a Ford Bronco®. The tailgate TG of the vehicle V can be a swingout tailgate TG. The tailgate TG is attached by hinges H on a right side S of the tailgate TG to the frame F of the vehicle V that permits the tailgate TG to open in a rotational manner about an axis that runs through the hinges H. As shown in FIGS. 1A-1C, an embodiment of a storage cabinet 10 can be installed in the tailgate TG. For example, the storage cabinet 10 can be installed in an access aperture in an interior facing portion of the tailgate TG of the vehicle V to provide extra storage that can be designated for specific uses so that the user of the vehicle V knows where to locate them when needed. For instance, in some embodiments of a vehicle, like the 2021, 2022, 2023, 2024 Ford Broncos®, a side L of the tailgate TG opposite the side S on which the hinges H are located can have a locking compartment RC in which the latch access aperture can be provided to allow access to the latching or locking mechanism that locks the tailgate TG closed when the tailgate TG is shut.

The storage cabinet 10 can be used for different purposes and to hold a variety of different items. For example, the storage cabinet 10 can be used as a medicine cabinet that can house first aid kits that can include bandages, tape, gauze, medicines, ointments, first aid equipment, and the like. The storage cabinet 10 can also be used to lock up a weapon such as a firearm. Additionally, the storage cabinet 10 can be used to hold other valuables that are preferrable hidden or kept in a locked, safe place. Further, the storage cabinet 10 can be used to hold a variety of other items and have a variety of other uses.

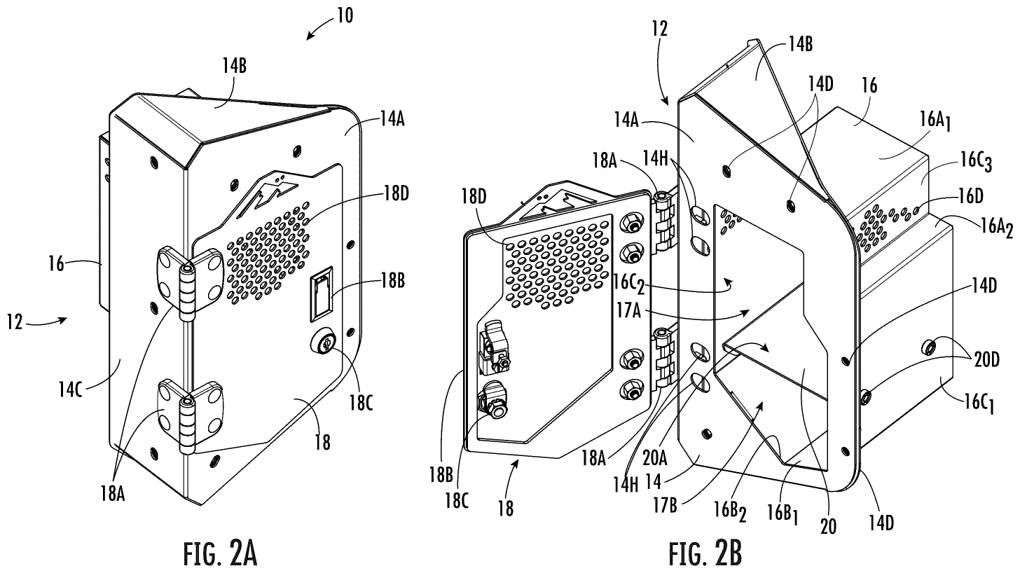

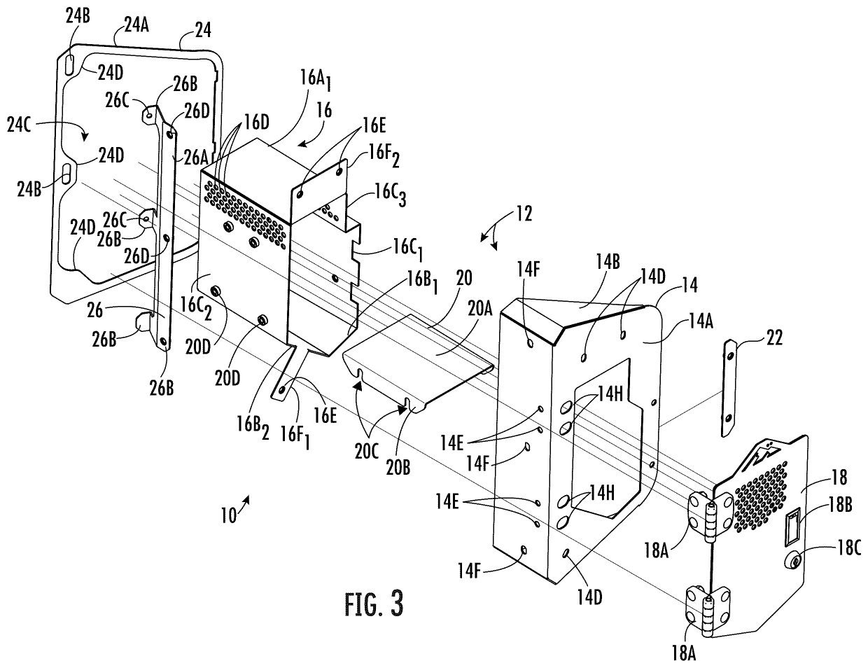

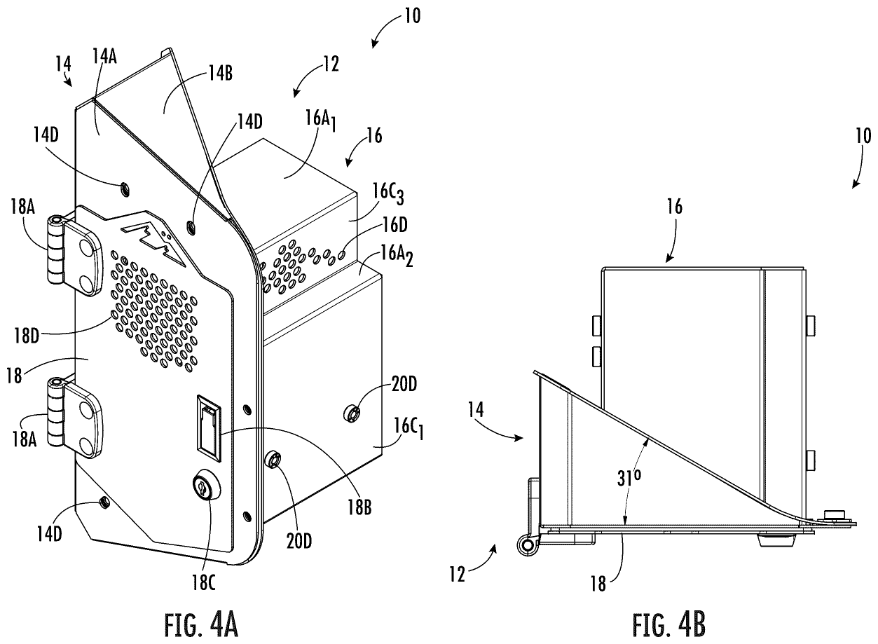

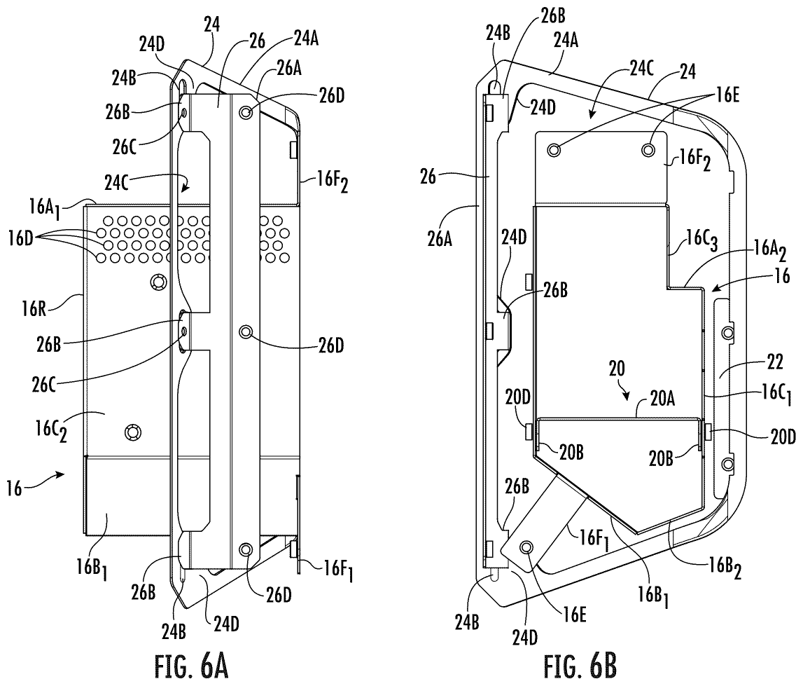

The storage cabinet 10 can have a variety of different components to facilitate its installation into the tailgate TG. Referring to FIGS. 2A-6B, a storage cabinet 10 can be provided that comprises a cabinet body 12 comprising a compartment structure 16 having one or more compartment cavities 17A, 17B within the compartment structure 16 that open on a face side of the compartment structure 16. The compartment structure 16 can comprise a variety of side walls 16A₁, 16A₂, 16B₁, 16B₂, 16C₁, 16C₂, and 16C₃, as well as a rear wall 16R (see FIG. 6A). The side walls 16A₁, 16A₂, 16B₁, 16B₂, 16C₁, 16C₂, and 16C₃, as well as a rear wall can form a size and shape of the compartment structure 16 that can fit in the access aperture and the locking compartment RC of the tailgate TG of the vehicle V. In some of the side walls 16A₁, 16A₂, 16B₁, 16B₂, 16C₁, 16C₂, and 16C₃, vent holes 16D can be included.

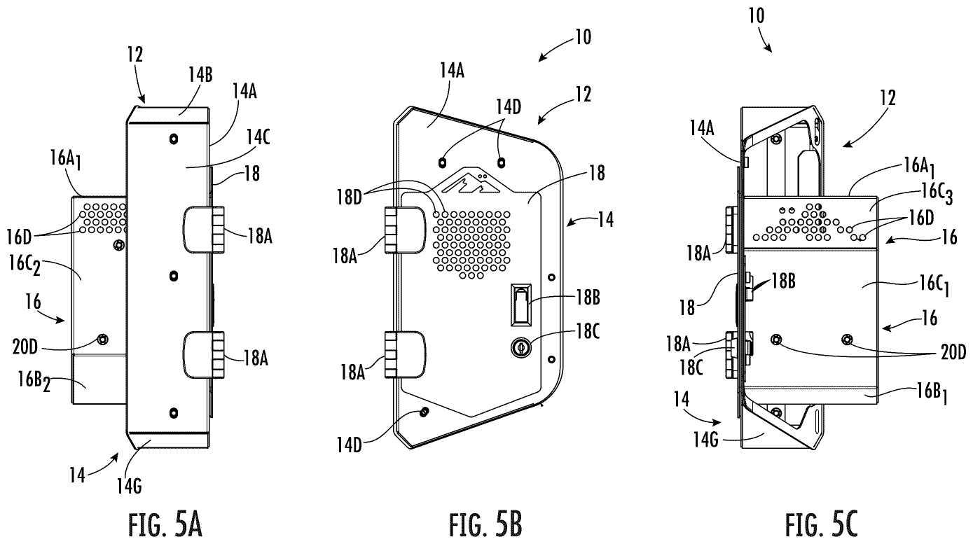

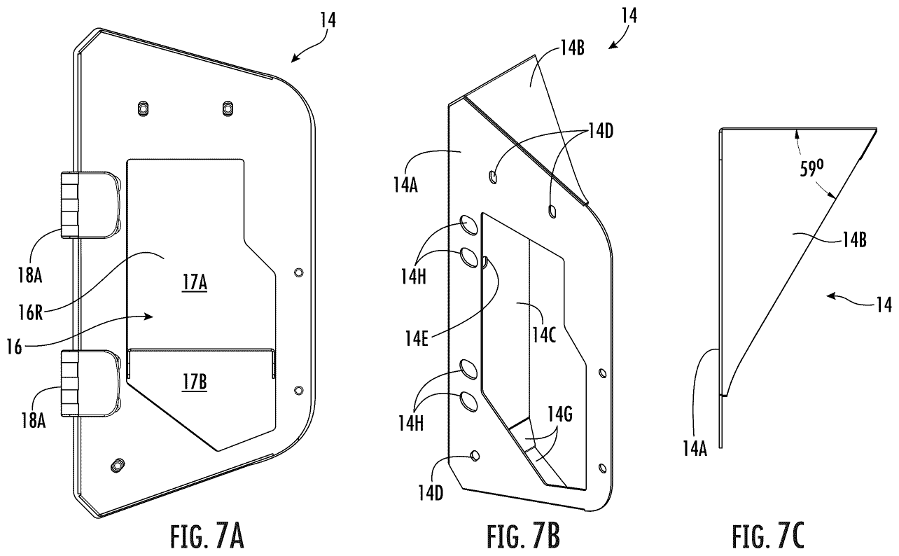

Referring to FIGS. 2A-5C and 7A-7C, the cabinet body 12 can also comprise an exterior cabinet wall structure 14 securable to the compartment structure 16. The exterior cabinet wall structure 14 can be configured to form at least a front face 14A of the cabinet body 12. For example, the exterior cabinet wall structure 14 can comprise an exterior top wall portion 14B, an exterior side wall portion 14C, and an exterior bottom wall portion 14G (see FIGS. 5A and 7B). When installed, the side wall portion 14B, exterior top wall portion 14C, and exterior bottom wall portion 14G can extend from the tailgate TG. For example, the exterior top wall portion 14B, an exterior side wall portion 14C, and an exterior bottom wall portion 14G can be configured such that the front face 14A extends outward from a side of the locking compartment RC of the tailgate TG and extends from an outward interior surface of the locking compartment RC in a parallel plane about flush with the outward interior surface of the locking compartment RC. In some embodiments, the exterior top wall portion 14B, an exterior side wall portion 14C, and an exterior bottom wall portion 14G can be contoured to fit the contour of the locking compartment RC the tailgate TG around the latch access aperture. For example, the exterior top wall portion 14B and an exterior bottom wall portion 14G can be slanted, curved, or sloped front a first side of the front face 14A of the exterior cabinet wall structure 14 to a second side from which the exterior side wall portion 14C extends.

The compartment structure 16 of the cabinet body 12 can be configured to reside within the latch access aperture, or opening, of the tailgate TG of the vehicle V. The storage cabinet 10 can also comprise a cabinet door 18 configured to attach the exterior cabinet wall structure 14 to close the one or more compartment cavities 17A, 17B in the compartment structure 16. One or more attachment arms 16F₁, 16F₂ can extend from the compartment structure 16 of the cabinet body 12. The attachment arms 16F₁, 16F₂ can be used to secure the compartment structure 16 to the exterior cabinet wall structure 14.

As shown in FIGS. 3 and 6B, the compartment structure 16 can comprise a detachable shelf 20 that can be installed into a single cavity to form the two compartment cavities 17A, 17B and can be removed from the compartment structure 16 to from a single cavity. The shelf 20 can have a horizontal floor 20A that forms a top surface of the shelf 20 and side flanges 20B that extend down from the horizontal floor 20A. The flanges 20B can have securement channels 20C therein that can engage shelf fasteners 20D that can be positioned in side walls 16C₁, 16C₂ of the compartment structure 16 to secure the shelf 20 in the compartment structure 16.

Referring to FIGS. 3 and 6A-6B, the storage cabinet 10 can also comprise a cabinet sealing gasket 24 having a compartment opening 24C therein. The cabinet gasket 24 can be configured to be securable around the opening in the tailgate TG of the vehicle V into which the compartment structure 16 is inserted. The opening in the tailgate TG can be, for example, the latch access aperture in the locking compartment RC in a Ford Bronco® that is proximate to the latch near the side L of the swingout tailgate TG. The storage cabinet 10 can further comprise a cabinet bracket 26 that is securable to the tailgate TG against the cabinet gasket 24. The cabinet gasket 24 can comprise a gasket body 24A. The gasket body 24 can comprise a malleable material to fit to the contours of the locking compartment RC around the latch access aperture. In some embodiments, the cabinet gasket 24 can have an adhesive backing to permit it to be secured to the locking compartment RC around the latch access aperture in the locking compartment RC. The cabinet bracket 26 can comprise feet 26B that are securable to the tailgate TG and the cabinet gasket 24 to stabilize the cabinet bracket 26 and secure it to the tailgate TG. The cabinet bracket 26 can have a securement bar 26A that extends above the feet 26B. The securement bar 26A can be securable to the exterior wall structure 14 of the cabinet body 12 to hold the exterior wall structure 14 of the cabinet body 12 in position on the tailgate TG of the vehicle V.

To attach the exterior cabinet wall structure 14, the exterior side wall portion 14C of the exterior cabinet wall structure 14 can be securable to the cabinet bracket 26 on an interior portion of the exterior side wall portion 14C of the exterior cabinet wall structure 14. For example, the securement bar 26A of the cabinet bracket 26 can have fastening apertures 26D that can be aligned with fastening apertures 14F in the exterior side wall portion 14C of the exterior cabinet wall structure 14 with the securement bar 26A of the cabinet bracket 26 pressed against the interior portion of the exterior side wall portion 14C of the exterior cabinet wall structure 14.

The cabinet gasket 24 can comprise a gasket body 24A with fastening apertures 24B in the gasket body 24A that can be aligned with fastening apertures in the tailgate to permit the bracket 26 to be attached to the tailgate TG. In particular, in some embodiments, a plurality of projections 24D can extend inward along an edge of the compartment opening 24C. These projections 24D can be aligned with projections located in the tailgate TG around the access aperture into which the compartment structure 16 is be inserted. At least some of these projections 24D on the tailgate can include fastening apertures 24B use to fasten a cover for the access aperture onto the tailgate TG. The projections 24D on the cabinet gasket 24 once secured to the tailgate TG that provides a firm backing can provide a stabilization surface on which a foot 26B of the feet 26B of the cabinet bracket 26 is configured to rest. One or more of the feet 26B of the cabinet bracket can have fastening apertures 26C that can be used to secure the cabinet bracket 26 to the tailgate through alignment with the fastening apertures 24B in the cabinet gasket 24 and fastening apertures in the projections in the tailgate TG and inserting fasteners the respective fastening apertures such that the respective foot 26B of the cabinet bracket 26 resides against the stabilization surface of the cabinet gasket 24.

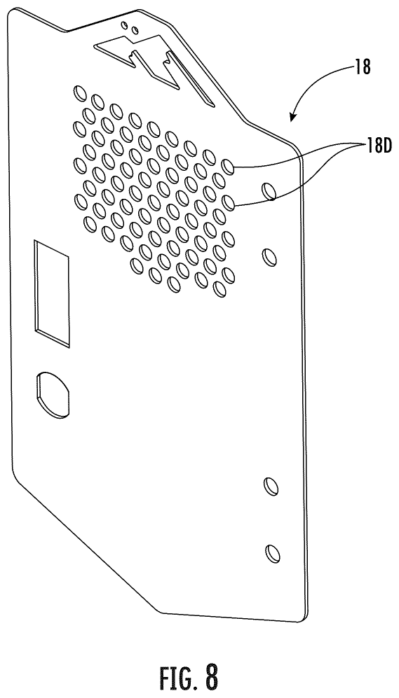

Referring to FIGS. 2A-5C and 8, the cabinet door 18 can comprise hinges 18A securable to the exterior side wall portion 14C of the exterior cabinet wall structure 14. For example, fasteners can be used to secure the hinges 18A to the exterior side wall portion 14C of the exterior cabinet wall structure 14 via fastening apertures 14E in the exterior side wall portion 14C of the exterior cabinet wall structure 14. The front face of 14A of the exterior cabinet wall structure 14 can also have hinge receiving apertures 14H for receiving fastener portions of the hinges 18A that connect the hinges 18A to the door 18. In this manner, the door 18 can reside flat against the front face of 14A of the exterior cabinet wall structure 14. Additionally, the cabinet door 18 can comprise at least one of a latch 18B or lock 18B to secure the door 18 closed against the front face 14A of the exterior cabinet wall structure. To facilitate the locking and/or closing of the door, a locking plate 22 can be secured on an interior portion of the front face 14A of the exterior wall structure 14 that is configured to be engaged by the at least one of a latch 18A or lock 18B of the cabinet door 18. In some embodiments, the storage cabinet door 18 can include invent holes 18D that can permit air flow into the one or more compartment cavities 17A, 17B in the compartment structure 16.

To secure the compartment structure 16 in place with a proper align with the exterior cabinet wall structure 14, the front face 14A of the exterior cabinet wall structure 14 can be secured to at least one of the one or more attachment arms 16F₁, 16F₂ extending from the compartment structure 16. This attachment of the front face 14A of the exterior cabinet wall structure 14 to the compartment structure 16 can occur before installation of the cabinet body in the latch access aperture in the locking compartment RC. For example, in some embodiments, the attachment arms 16F₁, 16F₂ of the compartment structure 16 can have fastening apertures 16E therein and the front face 14A of the exterior cabinet wall structure 14 can have fastening apertures 14D that can be aligned with the fastening apertures 16E of the attachment arms 16F₁, 16F₂ of the compartment structure 16. Fasteners can be inserted into the aligned the fastening apertures 14D of the front face 14A of the exterior cabinet wall structure 14 and the fastening apertures 16E of the attachment arms 16F₁, 16F₂ of the compartment structure 16 and tightened so that the front face 14A of the exterior cabinet wall structure 14 are secured against the compartment structure 16. The attachment arms 16F₁, 16F₂ of the compartment structure 16 can be on different sides of the compartment structure to facilitate a stable connection between the front face 14A of the exterior cabinet wall structure 14 and the compartment structure 16, for example, on opposing sides of the compartment structure 16. The position of the attachment arms 16F₁, 16F₂ of the compartment structure 16 can be chosen to aid in the fitting of the compartment structure 16 in the opening of the tailgate TG.

Thus, as disclosed herein, a storage cabinet and storage cabinet system can be provided that is configured to be installed into a tailgate of a vehicle. The tailgate can be a swingout tailgate such as the one provided on the 2021, 2022, 2023, and 2024 Ford Bronco®. These tailgates provide a latching mechanism access aperture in the interior facing portion of the tailgate that permits access to the latching mechanism used to hold the swingout tailgate closed. The cover used to enclose the access aperture can be removed and the cabinet system can be installed in the latch access aperture. The storage cabinet system as described above can comprise a cabinet gasket having a compartment opening therein configured to be securable around the access aperture in the tailgate of the vehicle into which the compartment structure will be inserted. The cabinet gasket can comprise a pliable material that permits the cabinet gasket to fit the contour of the locking compartment in which the latch access aperture resides in the tailgate. The pliable material can comprise a pliable plastic, a foamed plastic polymer, a gel plastic polymer, or the like. The cabinet gasket can be configured to have an interior aperture that has the same or similar shape as the outline of the access aperture in the tailgate. The cabinet gasket can have projections at a first side. For example, the projections can be at a top corner, a bottom corner, and a middle portion between the top and bottom corners. These projections can correspond to projections on the tailgate that form a portion of the access aperture in the tailgate.

The storage cabinet system can also comprise a cabinet bracket that comprises feet that are securable to the tailgate against the cabinet gasket. The cabinet bracket can be secured to the exterior wall structure of the cabinet body to hold the exterior wall structure of the cabinet body in position on the tailgate of the vehicle. In some embodiments, the feet of the cabinet bracket can correspond to the projections of the cabinet gasket. The cabinet bracket can comprise feet that are securable to the tailgate and the cabinet gasket to stabilize the cabinet bracket. These projections on the tailgate can include fastening apertures use to fasten a cover for the access aperture onto the tailgate. The projections on the cabinet gasket can provide a stabilization surface on which a foot of the feet of the cabinet bracket is configured to rest when the cabinet bracket is secured tot eh tailgate. One or more of the feet of the cabinet bracket can be secured to the projection in the tailgate using the fastening apertures in the projections on which the respective foot resides against the stabilization surface of the cabinet gasket.

The cabinet bracket can have a securement bar the extend above the feet. The securement bar can be used to secure the storage cabinet in position on the tailgate of the vehicle as explained further below. The storage cabinet system can also comprise a cabinet body that can comprise a compartment structure having one or more compartment cavities that open on a face side of the compartment structure within the compartment structure. Additionally, the cabinet body can comprise an exterior cabinet wall structure securable to the compartment structure and configured to form at least a front face of the cabinet body. The compartment structure of the cabinet body can be configured to reside within an opening of the tailgate of the vehicle. Further, the storage cabinet system can comprise a cabinet door that can be configured to attach the cabinet wall structure to close the one or more compartment cavities in the compartment structure. The compartment structure can have one or more attachment arms that extends from the compartment structure of the cabinet body that can configured to engage a portion of the front face of the exterior wall structure. The exterior cabinet wall structure can comprise an exterior side wall portion, an exterior top wall portion, and an exterior bottom wall portion of the cabinet body that extend from the tailgate. The exterior side wall portion of the exterior cabinet wall structure can be secured to the securement bar of the cabinet bracket. For example, the securement bar of the cabinet bracket can be positioned against an interior portion of the exterior side wall portion of the exterior cabinet wall structure. For example, the securement bar of the cabinet bracket can have fastening apertures that can be aligned with fastening apertures in the exterior side wall portion of the exterior cabinet wall structure with the securement bar of the cabinet bracket being pressed against the interior portion of the exterior side wall portion of the exterior cabinet wall structure. The fasteners can tightly hold the securement bar of the cabinet bracket to the exterior side wall portion of the exterior cabinet wall structure such that the storage cabinet body is held in place with the compartment structure within the access aperture and the exterior cabinet wall structure firmly against the tailgate.

As disclosed herein and described above, methods of assembly and installation are provided herein. For example, a method for securing a storage cabinet in a tailgate of a vehicle can be provided. The method can comprise providing a cabinet body comprising a compartment structure having one or more compartment cavities that open on a face side of the compartment structure within the compartment structure and an exterior cabinet wall structure. The method can comprise inserting the compartment structure into an opening of the tailgate of the vehicle and securing the compartment structure to the tailgate. The method can also comprise securing the exterior cabinet wall structure to the compartment structure to form a front face of the cabinet body. Further, the method can comprise attaching a cabinet door configured to the exterior cabinet wall structure to close the one or more compartment cavities in the compartment structure. The cabinet body can comprise one or more attachment arms that extends from the compartment structure of the cabinet body. In such embodiments, the exterior cabinet wall structure can be secure to at least one of the one or more attachment arms.

For Installation, the compartment structure can be secured to the front face of the exterior cabinet wall structure as described above. The cabinet gasket can be secured on the tailgate around the access aperture in the tailgate. The cabinet bracket can be installed on a side of the cabinet gasket with the feet of the cabinet bracket against a portion of the cabinet gasket and the securement bar of the cabinet bracket extending upward above the feet of the cabinet bracket. The rear of the compartment structure that is attached to the exterior cabinet wall structure can be inserted in the aperture of the cabinet gasket and the access aperture. The securement bar of the cabinet bracket can be pressed against the interior portion of the exterior side wall portion of the exterior cabinet wall structure. The fasteners can be inserted in the fastening apertures of the securement bar of the cabinet bracket and the fastening apertures of the exterior side wall portion of the exterior cabinet wall structure and then tightened to hold the securement bar of the cabinet bracket to the exterior side wall portion of the exterior cabinet wall structure such that the storage cabinet body is held in place with the compartment structure within the access aperture and the exterior cabinet wall structure firmly against the tailgate.

These and other modifications and variations to the present subject matter may be practiced by those of ordinary skill in the art, without departing from the spirit and scope of the present subject matter, which is more particularly set forth herein above and any appending claims. In addition, it should be understood the aspects of the various embodiments may be interchanged either in whole or in part. Furthermore, those of ordinary skill in the art will appreciate that the foregoing description is by way of example only, and is not intended to limit the present subject matter.

What is claimed is:

1. A storage cabinet configured to reside in a tailgate of a vehicle, the storage cabinet comprising:
a cabinet body comprising a compartment structure having one or more compartment cavities that open on a face side of the compartment structure within the compartment structure and an exterior cabinet wall structure securable to the compartment structure and configured to form at least a front face of the cabinet body, the compartment structure of the cabinet body configured to reside within an opening of the tailgate of the vehicle; and
a cabinet door configured to attach the exterior cabinet wall structure to close the one or more compartment cavities in the compartment structure.

2. The storage cabinet according to claim 1, wherein the compartment structure comprises a detachable shelf that can be installed into a single cavity of the one or more compartment cavities to form two compartment cavities and can be removed from the single cavity.

3. The storage cabinet according to claim 1, further comprising a cabinet gasket having a compartment aperture therein configured to be securable around the opening in the tailgate of the vehicle into which the compartment structure is inserted.

4. The storage cabinet according to claim 3, further comprising a cabinet bracket comprising feet that are securable to the tailgate against the cabinet gasket and the cabinet bracket being securable to the exterior cabinet wall structure of the cabinet body to hold the exterior cabinet wall structure of the cabinet body in position on the tailgate of the vehicle.

5. The storage cabinet according to claim 4, wherein the exterior cabinet wall structure comprises an exterior side wall portion, an exterior top wall portion, and an exterior bottom wall portion that extend from the tailgate.

6. The storage cabinet according to claim 5, wherein the exterior side wall portion of the exterior cabinet wall structure is securable to the cabinet bracket on an interior portion of the exterior side wall portion of the exterior cabinet wall structure.

7. The storage cabinet according to claim 6, wherein the cabinet gasket comprises a plurality of projections along an edge of the compartment aperture, each of the plurality of projections providing a stabilization surface on which a foot of the feet of the cabinet bracket is configured to rest.

8. The storage cabinet according to claim 7, wherein one or more of the feet of the cabinet bracket are securable to a projection of the plurality of projections on which the respective foot resides.

9. The storage cabinet according to claim 5, wherein the cabinet door comprises hinges securable to the exterior side wall portion of the exterior cabinet wall structure.

10. The storage cabinet according to claim 9, wherein the cabinet door comprises at least one of a latch or lock to secure the cabinet door closed against the front face of the exterior cabinet wall structure.

11. The storage cabinet according to claim 10, further comprising a locking plate that is securable on an interior portion of the front face of the exterior cabinet wall structure that is configured to be engaged by at least one of the latch or lock of the cabinet door.

12. The storage cabinet according to claim 1, further comprising one or more attachment arms that extends from the compartment structure of the cabinet body with at least one of the one or more attachment arms being configured to engage a portion of the front face of the exterior cabinet wall structure.

13. The storage cabinet according to claim 12, wherein the front face of the exterior cabinet wall structure is securable to at least one of the one or more attachment arms extending from the compartment structure.

14. A storage cabinet system for securing in a tailgate of a vehicle, the storage cabinet system comprising:
a cabinet gasket having a compartment aperture therein configured to be securable around an opening in the tailgate of the vehicle;
a cabinet bracket comprising feet that are securable to the cabinet gasket;
a cabinet body comprising a compartment structure having one or more compartment cavities that open on a face side of the compartment structure within the compartment structure and an exterior cabinet wall structure securable to the compartment structure and configured to form at least a front face of the cabinet body, the compartment structure of the cabinet body configured to reside within the opening of the tailgate of the vehicle and the cabinet bracket being securable to the exterior cabinet wall structure of the cabinet body to hold the exterior cabinet wall structure of the cabinet body in position on the tailgate of the vehicle;
a cabinet door configured to attach the exterior cabinet wall structure to close the one or more compartment cavities in the compartment structure; and
one or more attachment arms that extends from the compartment structure of the cabinet body with at least one of the one or more attachment arms being configured to engage a portion of the front face of the exterior cabinet wall structure.

15. The storage cabinet system according to claim 14, wherein the exterior cabinet wall structure comprises an exterior side wall portion, and exterior top wall portion and an exterior bottom wall portion of the cabinet body that extend from the tailgate.

16. The storage cabinet system according to claim 15, wherein the exterior side wall portion of the exterior cabinet wall structure is securable to the cabinet bracket on an interior portion of the exterior side wall portion of the exterior cabinet wall structure.

17. The storage cabinet system according to claim 16, wherein the cabinet gasket comprises a plurality of projections along an edge of the compartment aperture, each of the plurality of projections providing a stabilization surface on which a foot of the feet of the cabinet bracket is configured to rest.

18. The storage cabinet system according to claim 17, wherein one or more of the feet of the cabinet bracket are securable to the tailgate on a projection of the plurality of projections on which the respective foot resides.

19. A method for securing a storage cabinet in a tailgate of a vehicle, the method comprising:
providing a cabinet body comprising a compartment structure having one or more compartment cavities that open on a face side of the compartment structure within the compartment structure and an exterior cabinet wall structure;
inserting the compartment structure into an opening of the tailgate of the vehicle and securing the compartment structure to the tailgate;
securing the exterior cabinet wall structure to the compartment structure to form a front face of the cabinet body; and
attaching a cabinet door configured to the exterior cabinet wall structure to close the one or more compartment cavities in the compartment structure.

20. The method according to claim 19, wherein the cabinet body further comprises one or more attachment arms that extends from the compartment structure of the cabinet body; and
the step of securing the exterior cabinet wall structure to the compartment structure comprises securing the exterior cabinet wall structure to at least one of the one or more attachment arms.
